(19) United States
(12) Patent Application Publication
(10) Pub. No.: US 2010/0088752 A1
(43) Pub. Date: Apr. 8, 2010

(54) Identifier Binding for Automated Web Processing

(76) Inventors: Vikram Nagulakonda, Sunnyvale, CA (US); Venkata Subba Rao Ravilisetty, Dublin, CA (US); Lakshmi Narasimha Reddy Ankireddipally, Sunnyvale, CA (US)

Correspondence Address: JAY CHESAVAGE, 3833 MIDDLEFIELD, PALO ALTO, CA, 94303, US

(21) Appl. No.: 12/245,688

(22) Filed: Oct. 3, 2008

(51) Int. Cl. H04L 9/32; G06F 21/20

(52) U.S. Cl. 726/6; 726/7

(57) ABSTRACT

A process for the automatic handling of requests has a first step of receiving a session request, which results in the issuance of a session token. Upon receipt of a content transfer message accompanied by the previously issued session token, a routing tuple identifying a sender, receiver, and type, the content transfer message also containing content to be transferred, the routing tuple is compared to entries in a process table which resolves into an action and destination. The action and destination associated with the routing tuple and request type are performed if a match is found, or a default action is taken if no match is found, such as placing the content in a user INBOX for future handling. Additionally, the later actions the user takes on the INBOX are examined, and new entries are created in the process table based on the user actions.

### FIELD OF THE INVENTION

The present invention relates to the use of a personal identifier for use in automating the handling of content associated with the personal identifier.

### BACKGROUND OF THE INVENTION

U.S. Pat. No. 5,732,397 describes a system for making current decisions based on data saved about a user making decisions. U.S. Pat. No. 5,963,931 describes a system for interrogating a user before making decisions for the user. U.S. Patent Application 2008/0183546 describes a system for assigning a sales lead to a particular sales person based on historical information about the agent and information about the sales lead. U.S. Pat. No. 6,771,164 describes a system for a system to uniquely identify itself to a network. It is desired for a system to send requests which include content for automatic processing by a server, the request including sender and recipient information, and the automatic processing to be performed according to processing rules derived from previous user decisions on content with similar attributes, including sender identifier and destination identifier.

### OBJECTS OF THE INVENTION

A first object of this invention is a system and process for handling content associated with an account identifier accompanied by a routing tuple having a Sender_ID, Receiver_ID, and Type_ID.

A second object of the invention is the generation of a session token for use in combination with a routing tuple having a sender identifier (Sender_ID), receiver identifier (Receiver_ID), type identifier (Type_ID), and optional content to be automatically processed according to processing rules.

A third object of the invention is a method for learning user behaviors and conversion of previous user behaviors into processing rules based on the examination of previous user selections, thereafter using the processing rules to make future selections for a user.

### SUMMARY OF THE INVENTION

A process which receives a session request message having at least a request type, an account identifier (Acct_ID), a device identifier (Device_ID), a hashed personal identifier number (hashed PIN), and a session validity period results in the issuance of a session token which contains the account identifier, the device identifier, a unique session identifier, an expiration timestamp, and a hash which operates over the other fields of the session token. Upon presentation of a content transfer request message which contains the previously issued session token, a routing tuple, and content, the routing tuple having at least a sender_ID, receiver_ID, and type_ID, the content is handled according to the contents of a matching entry in a processing rules table which is searched using the routing tuple, the entry matching the routing tuple also having an action field and an optional destination field describing how to handle the content associated with the matching routing tuple, and optionally where to place the content, respectively. Content accompanied by a routing tuple which does not match an entry of the processing rules is directed to a default location such as an INBOX for later handling by the user. When the user later handles the contents of the INBOX, a process examines the user handling of the content associated with each tuple, and forms new entries to the table of processing rules for use when future content arrives from the same source and type.

### BRIEF DESCRIPTION OF THE DRAWINGS

FIG. 1A shows the contents of an identifier.

FIG. 1B shows the contents of a session request message.

FIG. 1C shows the contents of a session token.

FIG. 1D shows the contents of a routing tuple.

FIG. 1E shows the contents of a content transfer message.

FIG. 1F shows the contents of a return message.

FIG. 2 shows a transaction versus time plot for a client agent and a server.

FIG. 3A shows a network camera agent.

FIG. 3B shows a camera service operating on a server.

FIG. 4 shows a flowchart for processing of an HTTP session token request.

FIG. 5 shows a flowchart for processing of a camera content request.

FIG. 6A shows a table of processing rules.

FIG. 6B shows a flowchart for examining user actions to form new processing rules.

FIG. 7 shows a flowchart for content request processing.

### DETAILED DESCRIPTION OF THE INVENTION

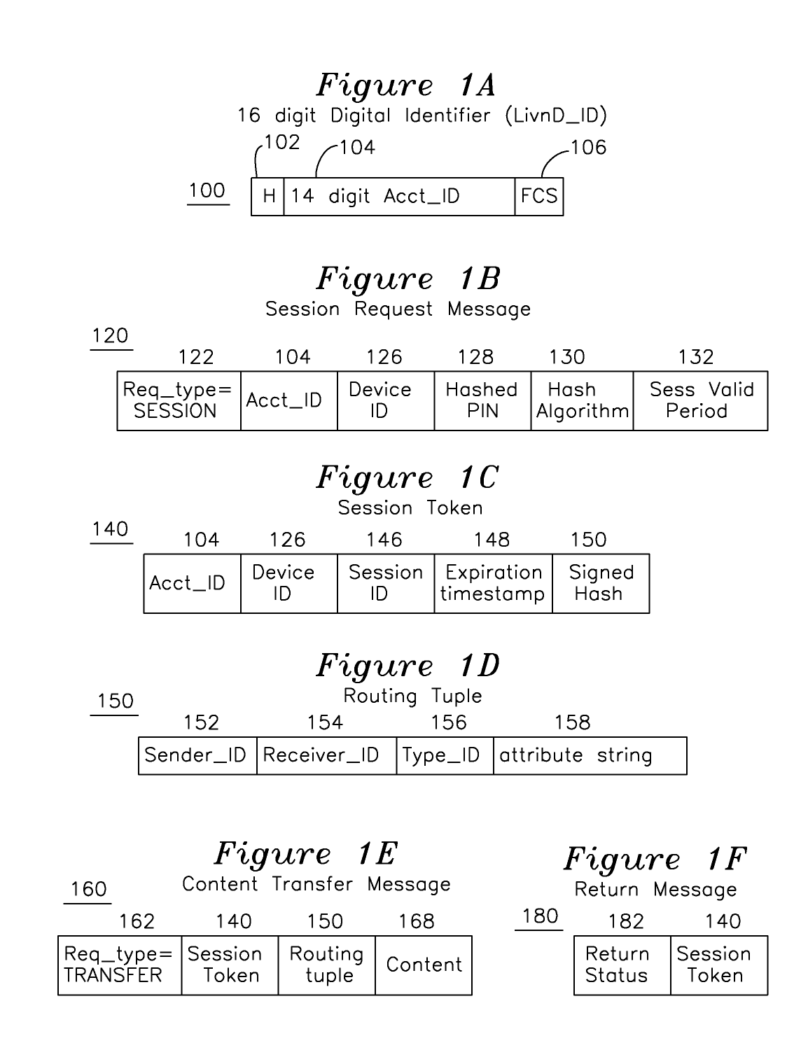

FIG. 1A shows a digital identifier 100 which includes an industrial identifier H 102, an account identifier (Acct_ID) 104, and a field check sum 106. In one embodiment of the invention, each digit is a numerical digit in the range 0-9 for ease of human use, and the total length of the identifier 100 is 16 digits for providing sufficient unique coverage over a variety of users without burdening each user with remembering an excessively long identifier. In other embodiments of the invention, hexadecimal or alphanumeric digits may be used, as well as a longer or shorter identifier 100 length. For a numerical digit assignment, the identifier 100 may consist of a single digit H (high digit) field 102, a 14 digit account identifier 104 which includes an issuer identifier such as a 5 digit value, and an account number such as a 9 digit number. The FCS 106 is a single digit which operates over the entire field and validates the values of the identifier, such that the algorithm for generating FCS 106 provides some basic assurance that a 16 digit identifier is constructed in a valid manner. One such algorithm for the generation of a single digit FCS 106 is Luhn's algorithm described in U.S. Pat. No. 2,950,048. For example, the digital identifier 8111-1100-0000-1236 may comprise an H field of 8, issuer identifier of 11111, account number of 000000123 and FCS of 6.

FIG. 1B shows a device session request message 120, which includes a request type (Req_type) 122, account identifier (Acct_ID) 104, device identifier (Device ID) 126, a hashed personal identifier (hashed PIN) 128, a hash algorithm identifier 130, and a requested session validity period 132 which indicates the time duration of the requested session. The request type 122 may include a session request type (SESSION) to generate a session token or a transfer request type (TRANSFER) to initiate a content transfer, as will be described later. The identifier 100 of request message 120 was described in FIG. 1A. The device identifier 126 is uniquely assigned and also identifies the manufacturer, and the device identifier may be a 16 digit value, such as 0000-0000-0000-0025. The hashed PIN 128 is a polynomial such as a hash derived from a personal identification number (PIN) which allows the user identifier to be tested such as by comparing the hash of the user PIN with the hashed PIN 128. The hash algorithm identifier 130 describes the type of hash used to generate the hashed PIN 128, and the hash algorithm type 130 may include MD5, SHA1, or any known algorithm for generating a hash from a PIN. The session valid period 132 is the length of time that the session associated with a session request 120 may be valid.

After request of a session, such as by presentation of a request 120 with a session request type in field 122, a session token 140 shown in FIG. 1C is returned. For the session token 140, the first field 104 is the account identifier Acct_ID 104 described in FIG. 1A, and the next field shown is a device identifier 126 such as was described for FIG. 1B. The session identifier 146 is assigned at the time of session creation, such as a 32 bit integer, and the expiration timestamp 148 describes the time at which the session expires in a location-independent manner, such as Universal Coordinated Time (UTC) or provided by a network time protocol (NTP) server. Signed hash 150 operates over the preceding fields 104, 126, 146, and 148, such that those values may be hashed and verified against signed hash 150.

FIG. 1D shows a routing tuple 150, which includes a sender identifier 152, such as an identifier 100 belonging to the sender, a receiver identifier 154 such as an identifier 100 belonging to the receiver, and a type identifier 156 which identifies the type of content being transferred, such as any attachment type described in multipurpose internet mail extension (MIME). An optional attribute string 158 may contain a string with one or more name=value pairs such as “size=25k;owner=JaneDoe”, or other attributes of use to the receiving system related to processing the associated content.

FIG. 1E shows a content transfer message 160, which includes a transfer request type (TRANSFER) for request type 162 accompanied by a session token 140 as was described earlier, a routing tuple 150 as was described earlier, and content 168, representing the actual data to be transferred.

FIG. 1F shows a return message 180, which includes a return status 182 and session token 140 as was described for FIG. 1C. In one embodiment of the invention, the return status types are:
0—success;
1—Transmission failed;
2—Hashes did not match;
3—Could not recognize the request;
4—Invalid session token;
5—Invalid content type;
6—Content size did not match;
7—Content format error;
999—unknown error.

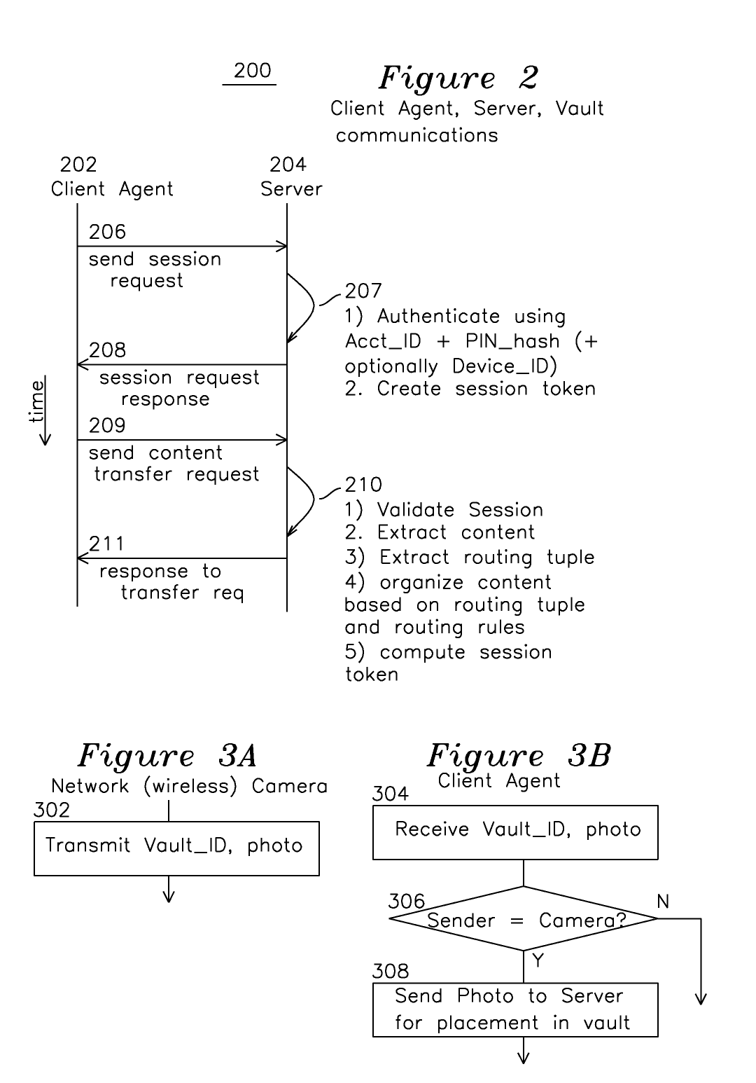

FIG. 2 describes the processing flow for a session request 206 followed by a transfer request 209. Client Agent 202 represents a program which is operative on a device, and server 204 represents a program which is operative on a server 204 connected to the device 202, such as by wired or wireless internet connection for connectionless data and TCP/IP for the actual data transport. Client agent 202 sends session request 206, such as 120 of FIG. 1B, to server 204, which may additionally reply with a request for a PIN or other authentication. Step 207 indicates any authentication steps which may be performed upon receipt of the session request 206. If a hashed PIN 128 is sent in request 120, it is compared with a local copy of the hashed PIN which is associated with the account identifier, such as is stored in an authentication server and associated with the account identifier. The hash algorithm 130 allows the transmission of a hashed PIN 128 using a variety of different hashing algorithms, each of which hash and hash type is accessible using the account identifier. Optionally, the device_ID may also be transmitted as part of the authentication, which may be beneficial to prevent the unauthorized use of previously issued authentication tokens by a different device. Another advantage of using the device identifier (device_ID) as part of the login is to allow multiple sessions with different devices and different PINs to uniquely define each session at the time of the initial request. If the authentication step 207 is successful, response 208 is made, which includes a session token with a valid time interval 148 such as token 140 of FIG. 1C. This combination of steps 206, 207, and 208 thereby provides a session which is uniquely identifiable from other sessions by the session identifier 146 of the issued session token 140. Step 209 indicates the sending of a content transfer request such as 160 of FIG. 1E, and the session identifier and contents of the routing tuple 150 are examined to determine that the requested session identifier exists, the destination device identifier exists, and content type is supported. Associated content 168 is extracted from the message 160 and handled according to the request type 162. Each content request 209 is thereafter acknowledged 211 by a return message 180 described in FIG. 1F.

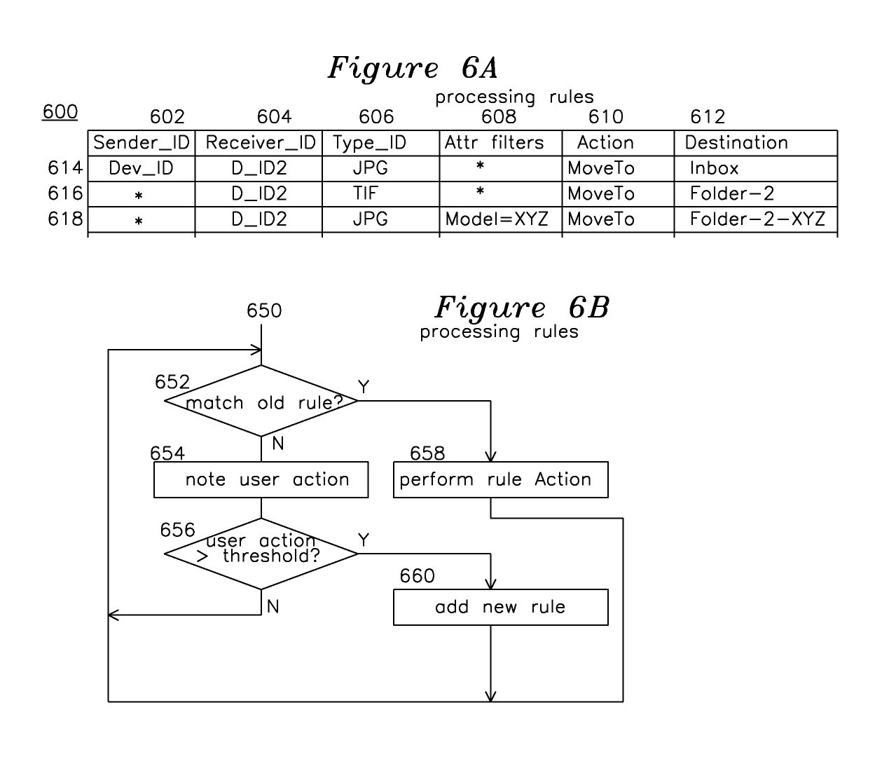

FIG. 3A show a camera task operating according to the present invention, where a camera agent 302 performs camera agent tasks associated with the content transfer and the server receives these requests 304, acts according to sender type 306 and handles the content 308. In this manner, an automated system may handle camera photos such that they may be placed on a server for sharing, for printing, or any other activity as proscribed by the processing rules as described for FIG. 6.

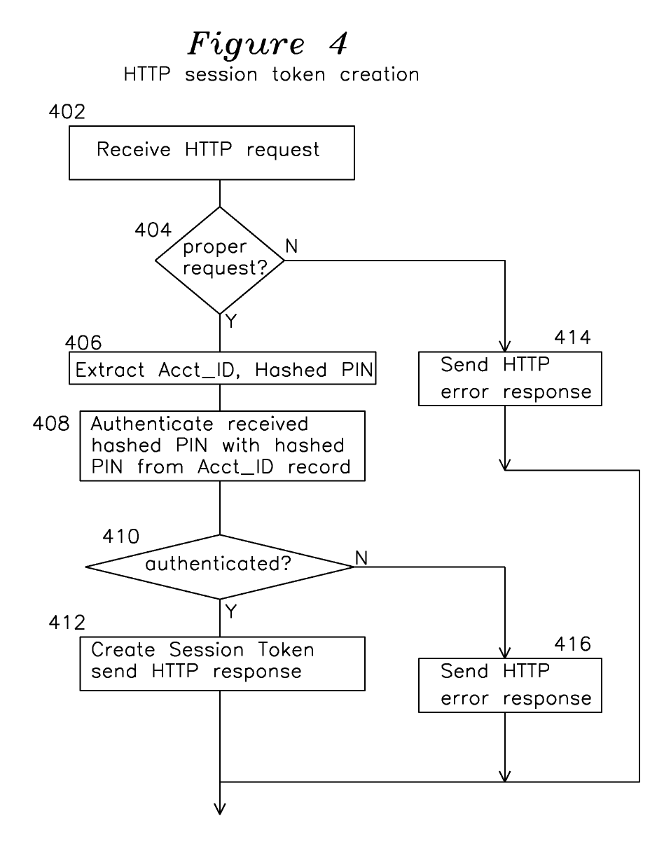

FIG. 4 shows a flowchart for a token request in a first activity which results in the creation of a session token. An HTTP request is received 402, such as a session request 120 described in FIG. 1B with Req_type=SESSION, and the request is checked to determine that the request is proper 404 by examining each of the fields of 120 to verify the account identifier (Acct_ID) 104 exists on the server, the device identifier (Device_ID) 126 is recognized, that the hashed PIN 128 sent with the request matches the hashed PIN stored on the server using the hash algorithm 130 specified. The hashed PIN 128 which is sent with the request can be stored on the device making the request, or the PIN may be prompted by the device, hashed, and sent along with the request. Optionally, the hash type can be negotiated during the initial connection. The session valid period 132 is checked to verify that the session period request falls within expected request limits. If any of the fields of the request is not proper, an error response is sent 414 such as with the return message 180 of FIG. 1F. If the request is proper, the account identifier 104 and hashed PIN 128 are extracted 406 and compared with the account identifier record in step 408, and if they match 410, a session token such as 140 of FIG. 1C is returned 412. If the authentication fails, an error response in the form of return message 180 of FIG. 1F is returned.

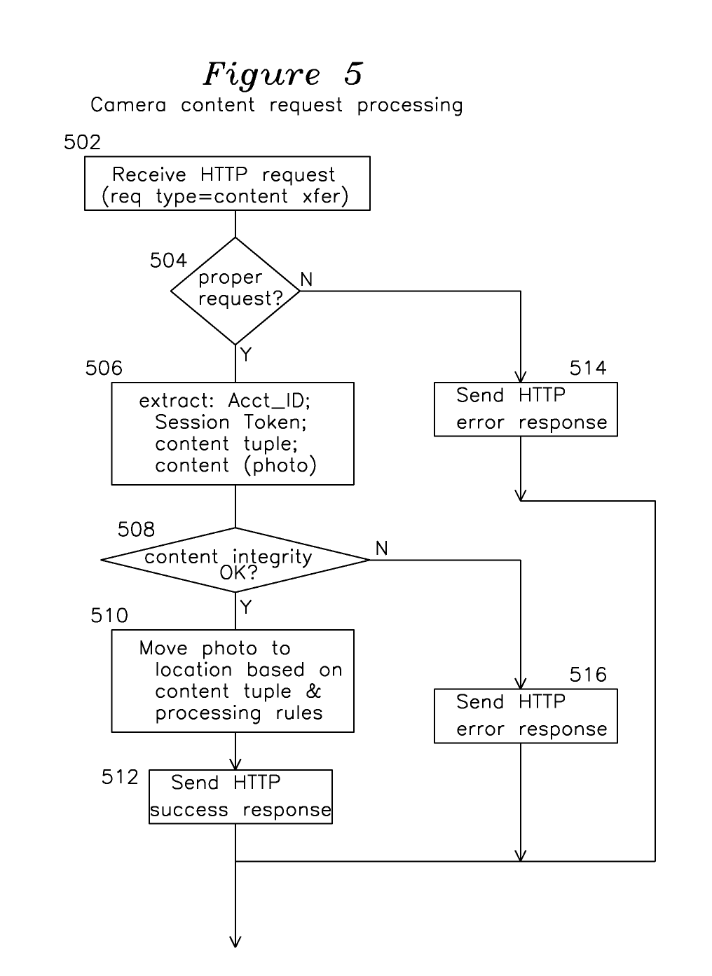

FIG. 5 shows the flowchart for handling of content from a content transfer message 160 of FIG. 1E after a session request 120 has been acknowledged with a session token 140 of FIG. 1C. The session token 140 of FIG. 1C is instantiated into the content transfer message 160 which has a transfer request type, shown as being received in step 502 of FIG. 5. The content transfer request is examined for completeness 504, such as previously described by examining the session token 140 of request 160 to verify the device identifier 126, session identifier 146, timestamp 148 for non-expiration, and proper hash 150, after which the routing tuple 150 is examined, and the content 168 optionally separated. If the request is proper 504, the extracted fields 506 from the transfer request are isolated, and the content 168 is verified for integrity 508. If an improper request is received, an error message such as 180 of FIG. 1E is returned, as is also done 516 for the case where the content integrity test 508 fails. Based upon the fields extracted in step 506, the content 168 is transferred to storage or an email inbox based on processing rules in step 510, and an HTTP success response is sent such as was described in 180 of FIG. 1E.

FIG. 6A shows a table 600 of exemplar processing rules for use in understanding the automated processing aspects of the invention. The processing rules describe actions 610 and a destination 612 based on Sender_ID 602, Receiver_ID 604 and Attr filters 608 which correspond to values of the associated fields from the routing tuple 150. The doc_type field 606 and any other attributes were extracted from the attribute string field 158. In step 510 of FIG. 5, the described fields are extracted, a match is searched in processing rules table 6A, where a match with one of the entries 614, 616, 618 results in the associated action 610 and destination 612.

FIG. 6B shows the creation of new processing rules by examining manual user selections, such by adding rules based on selections a user makes in the disposition of the contents of the INBOX. When the system is unable to automatically move content according to processing rules such as FIG. 6A, the default action is to place the content in the user's inbox. When the user acts on the contents of the inbox and moves content into particular locations, the system observes these selections 654 and generates a set of prospective rules, which have the same fields as processing rules of table 600, and include additional fields such as the number of times that particular action has been performed. When the user exceeds a threshold 656 for a particular selection, a new rule based upon that handling may be added in step 660. In another embodiment of the invention, an incoming request accompanied by associated fields Sender_ID, Receiver_ID, Doc_type, and table 600 is searched for a first match 652. A match is found where all of the fields Sender_ID, Receiver_ID, and Type_ID either match or are not used, as indicated by a “*” in the corresponding table entry. The search for a match stops upon a first match with an entry in the processing rules table 600.

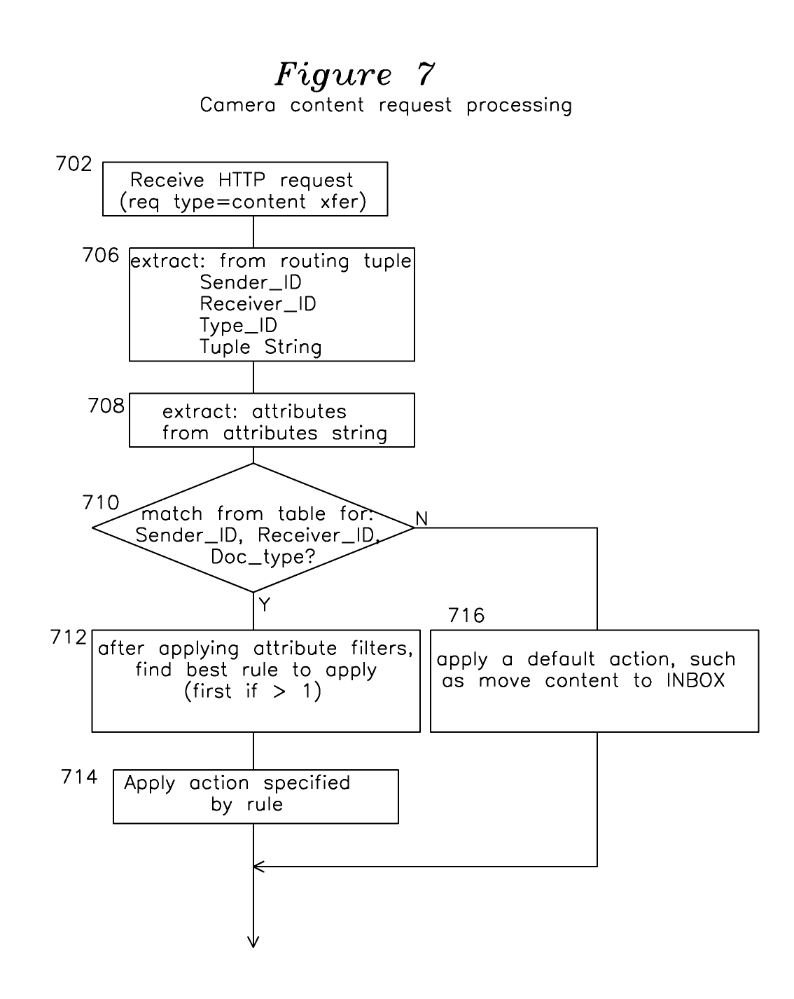

FIG. 7 shows another embodiment of the invention where a previously issued session token is used as part of a request for content transfer 702. The Sender_ID, Receiver_ID, Type_ID, and attribute String are extracted 706 from the tuple 150 of the request such as 160 of FIG. 1E. The attributes are extracted from the attribute string in step 708, and a match is searched 710 in table 600 based on Sender_ID, Receiver_ID, and Doc_type. If more than one matching entry is found, one or more of the “name=value” pairs in the attribute filter is used. If a content request message 160 has a routing tuple 150 which includes an attribute string, the server can use the attribute string to select a particular rule. For example, if the incoming request has a sender attribute string “sender=*” to indicate any sender, and the Owner is JaneDoe, the rule filter 714 can find entry table matches where “Sender_ID=JaneDoe”. The attribute string in the routing tuple 150 part of request 160 is thereby able to provide greater flexibility in matching to user-defined attributes in the processing rules table 600. If more than one matching table entry results after application of the attribute filters 712, then the first entry found is used. The content is thereafter handled 714 according to the matching rule. If no matching rule is found 716, then the content is moved to the user INBOX by default, and upon the user intervening to select and move images, new rules may be formed as was described for FIG. 6B.

I claim:

1) A process for handling of content for use by a server, the process operative on a computer and having the steps:
a first step of responding to a request for a session token, said request having at least a REQ_TYPE field, an Acct_ID field, a Device_ID field, a hashed PIN, and a session valid period;
a second step of validating the request of said first step by comparing said hashed PIN with a hashed PIN associated with said account identifier;
a third step if said request is valid of sending a session token which includes said Acct_ID value, a session_ID value, an expiration timestamp, and a hash of at least said Acct_ID, said session_ID, and said expiration timestamp;
a fourth step of accepting a content transfer message containing a request_type indicating a transfer, said session_ID from said third step, a routing tuple, and content;
said routing tuple including at least a sender_ID, a receiver_ID, and a type_ID, said routing tuple applied to a table of processing rule entries, each said entry having at least two fields corresponding to said routing tuple fields, each said entry having an associated action and destination which is applied to said content associated with said routing tuple which matches a corresponding field of at least one said routing table entry.

2) The process of claim 1 where said second step request type is a session request and said fourth step request type is a transfer request.

3) The process of claim 1 where said accepting a content transfer message includes placing said content into a folder using processing rules which include an action and destination which are performed upon a match between said processing rules and said routing tuple.

4) The process of claim 3 where said processing rules include a plurality of entries, each said entry having a sender_ID field, receiver_ID field, Type_ID field, and an associated action and destination to be applied to said content.

5) A resolution process operative on a processing rules table for handling content, the processing rules table having a plurality of entries, each entry having at least a device_ID, a receiver_ID, a Type_ID, an action, and a destination, the resolution process having:
a first step of accepting content accompanied by a routing tuple including a sender_ID value, a receiver_ID value, and a Type_ID value;
a second step of finding a match between said routing tuple and one or more of said entries;
a third step of reading said action and said destination associated with said entry;
a fourth step of performing said action on said content, including moving said content to said destination;
where if no match is found, moving said content to an INBOX location, and if more than one match is found, using an attribute to reduce the number of said matches, thereafter using at least the action associated with a first said remaining match.

6) The process of claim 5 where said attribute string is part of said routing tuple.

7) The process of claim 5 where said processing rules table is derived from previous user responses to default content placed in said INBOX using the associated routing tuple and user action for said content to form a new processing rule.

8) A process operative on a computer for transferring content, the process having the steps:
a first step of receiving a session request, the session request including a request type identifying a session request, a unique account identifier, a hashed personal identifier (PIN), and a device identifier;
a second step of authenticating said session request by comparing said hashed personal identifier with a hashed personal identifier associated with said account identifier, said authentication succeeding if said comparison results in a match;
a third step, upon said successful authentication, of issuing a session token, the session token having said device identifier, said account identifier, a unique session identifier, an expiration timestamp indicating when said session is no longer valid, and a hash which operates over at least said account identifier, said device identifier, said unique session identifier, and said expiration timestamp;
a fourth step of receiving a content transfer message including identifying a transfer request, said content transfer message having a valid said session token and content accompanied by a routing tuple containing a sender identifier, receiver identifier, type identifier and optional attribute string;
a fifth step of moving said content to a location according to said routing tuple matching said processing rules and indicating an action when said routing tuple matches at least one said processing rule, said action including a destination for said content.

9) The process of claim 8 where said routing tuple includes an attribute string containing at least one name=value pair.

10) The process of claim 8 where said processing rules includes a plurality of entries, each entry having a value for a Sender_ID, a Receiver_ID, a Type_ID, and an attribute filter, each said entry having a corresponding action and destination.

11) The process of claim 8 where said processing rules include a “match any” type for any of said Sender_ID, Receiver_ID, or Type_ID.

12) The process of claim 8 where said processing rules are derived from the previous disposition of said content by a user.

13) The processor of claim 8 where said action and destination are performed when a first said entry match in a sequence of searches is completed.

14) The processor of claim 8 where said processing rules include a default action of placing said content into a user INBOX.

15) A process operative on a computer for handling content, the process operative on a content transfer message, said process having:
a first step of receiving said content transfer message which includes a request type indicating a transfer, the content transfer message including a session token which includes an account identifier, device identifier, session identifier, expiration timestamp indicating when said token expires, and a hash of said account identifier, said device identifier, said session identifier, and said expiration timestamp, said content transfer message also having a routing tuple including a Sender_ID, a Receiver_ID, a Type_ID, an attribute string, and content;
a second step of examining a processing rules for a match, said processing rules including a plurality of entries, each said entry having a field associated with each of said routing tuple entries: said Sender_ID, said Receiver_ID, said Type_ID, said attributes, each said entry also having an associated action and a destination, such that when said tuple of a request matches one of said processing rules, said content is handled according to said action and said destination of said matching entry, and when no said match is found, performing a default action to move content to a default destination;
a third step of forming a new said processing rule including the action and destination of a user when said content is moved from said default destination.

16) The process of claim 15 where said attribute string includes one or more name=value pairs.

17) The process of claim 15 where said processing rules includes a “match any” instruction for one or more fields.

18) The process of claim 15 where said default action includes moving said content to a default destination.

19) The process of claim 15 where said default action includes moving said content to an INBOX, and said new processing rules are formed based on the handling of said content in said INBOX by a user.
